(19) United States
(12) Patent Application Publication
(10) Pub. No.: US 2011/0073243 A1
(43) Pub. Date: Mar. 31, 2011

(54) Drawing Process for the Continuous Fabrication of Nanofibers Made of a Variety of Materials

(76) Inventors: Min-Feng Yu, Champaign, IL (US); Abhijit P. Suryavanshi, Worthington, OH (US); Kyungsuk Yum, Champaign, IL (US)

(21) Appl. No.: 12/677,429

(22) PCT Filed: Sep. 12, 2008
(86) PCT No.: PCT/US08/76204

§ 371 Date: Nov. 30, 2010

Related U.S. Application Data
(60) Provisional application No. 60/972,571, filed on Sep. 14, 2007.

(51) Int. Cl. B29C 55/22; B29C 70/88; B82Y 40/00

(52) U.S. Cl. 156/167; 264/164; 264/171.13; 264/166; 977/890

(57) ABSTRACT

Direct-write techniques are provided for the high speed (up to millimeter per second) and continuous fabrication of elongated nanostructures such as nanofibers. The nanofibers may be of an ionic solid, a hydrated salt, a molecular solid, or aggregated colloidal particles such as semiconductor particles. The nanofibers may also be converted to other forms.

### CROSS REFERENCE TO RELATED APPLICATIONS

This application claims the benefit of U. S. Provisional Application No. 60/972,571, filed Sep. 14, 2007, which is hereby incorporated by reference to the extent not inconsistent with the disclosure herein.

### STATEMENT REGARDING FEDERALLY SPONSORED RESEARCH OR DEVELOPMENT

This invention was made with government support under Award No. DMI 0328162 awarded by the National Science Foundation. The government has certain rights in the invention.

### BACKGROUND OF THE INVENTION

This invention is in the field of fabrication of nanowires, nanofibers and other elongated nanostructures.

Direct-write fabrication allows for the precision engineering and multifunctional integration of microscale and nanoscale components^{l}. Many direct-write techniques, such as dip-pen nanolithography^{2,3}, laser or ultraviolet light-based holographic or stereo lithography^{4,5}, ink-jet printing⁶, electrochemical fountain pen nanofabrication^{7,8}, and pipette-based robocasting⁹ or drawing^{10,11,} have been developed and found applications in photonics, tissue engineering, multiplex sensory and microfluidics. Some of these techniques are capable of fabricating nanoscale structures but only for two-dimensional patterning^{2,3}, and some are capable of three-dimensional construction but only with microscale resolution or with limited choices of “ink” materials⁴⁻¹¹

Nain et al. report drawing of suspended polymer micro or nanofibers using glass micropipettes (Nain, A. S. et al. Applied Physics Lett., 2006, 89(18), 183105-7). The polymeric fibers were formed by drawing and solidification of a viscous liquid polymer solution (polystyrene in xylene, with a typical polystyrene molecular weight of 900,000 gm/mol) which is pumped through a glass micropipette. It was reported that fibers having a diameter less than 50 nm were drawn repeatedly.

Odarcuhu and Joachim report drawing of nanofibers made from a dispersion of colloidal gold particles containing citrate molecules (Europhysics Letters, 42(2), 1998, 215-220). The longest fibers reported were millimetric in length, with a diameter of about 100nm. It was stated that in most cases the fiber diameter was on the order of 20 nm and that only a few gold particles were embedded along the fiber.

U.S. Pat. No. 5,352,512 to Hoffman reports a method for forming microscopic hollow tubes having a wall thickness of at least one nanometer and a diameter of at least 5 nanometers. The method involves positioning fibers in a preform corresponding to the desired tube configuration and depositing a tube material on fibers to coat them, where the tube material has a lower rate of reaction or solvation at specific temperatures than the fibers. The coated fibers are then heated in a solvent or reactive environment to a temperature at which the fiber is removed at a rate which is at least 10 times faster than the rate at which the fiber coating is removed.

There remains a need in the art for improved methods of forming nanofibers, especially high speed methods capable of forming nanofibers of extended varieties and having a length of one centimeter or greater.

### BRIEF SUMMARY OF THE INVENTION

In an embodiment, the invention provides direct-write techniques for the high speed (up to millimeter per second) and continuous fabrication of elongated nanostructures such as nanofibers. Freestanding nanofibers, suspended or stacked nanofiber arrays, and even a continuously-wound nanofiber roll can be fabricated. In different embodiments, nanofibers with diameters down to 25 nm or lengths up to 1 meter can be made. The methods of the invention can also be used to make three-dimensional webs with nanoscale features or even hierarchical and heterogeneous structures across several length scales.

In an embodiment, the technique makes feasible the production-scale fabrication of nanofibers made of a vast assortment of materials, their combinations, or their derivatives from the chemical reactions commonly available to ionic solids. In one embodiment, the nanofibers are comprised of an ionic solid or a hydrated ionic solid. In another embodiment, the nanofibers are comprised of a non-polymeric molecular solid. In yet another embodiment, the nanofibers are comprised of aggregated colloidal particles.

In an embodiment, the nanofibers are formed through rapid precipitation of solute ions or neutral molecules from solution. At the start of the process, the solution-containing reservoir (oriented vertically or inclined to a substrate) approaches the substrate surface until a meniscus is established between the exit of the reservoir and a selected location on the substrate surface. Due to the fast evaporation of solvent from the meniscus, at least a portion of the solute material in the liquid meniscus forms a solid deposit on the substrate. The solid may nucleate on the substrate.

FIG. 1a schematically illustrates an intermediate stage of such a nanofiber drawing process. A meniscus (32) is formed between the exit end (12) of the reservoir (10) and the previously formed portion of the nanofiber (50). A volume of synthesis solution associated with the meniscus (the meniscus volume, 34) is formed at the exit aperture (14) of the synthesis solution reservoir. Fast evaporation of solvent results in precipitation of at least a portion of the solute from this nanoscale volume of synthesis solution. The partial pressure of solvent in the atmosphere surrounding the synthesis solution reservoir is controlled to ensure sufficiently fast evaporation of solvent from the meniscus volume. The liquid solution is continuously drawn out of the exit of the reservoir as the reservoir is smoothly pulled away from the substrate, forming a dynamically stable meniscus between the solid growth front and the moving exit of the pipette. Evaporation of the liquid in the meniscus volume yields a nanofiber made of the solid solute material. Even when the reservoir is not vertically inclined with respect to the substrate, the meniscus is not in contact with the substrate for at least a portion of the drawing process.

In one aspect, the invention provides a method for forming a nanofiber of an ionic solid or hydrated ionic solid, the method comprising the steps of:
a. providing a reservoir comprising a dispensing end, the dispensing end having an aperture less than or equal to 20 micrometers in diameter and the reservoir containing a synthesis solution comprising a plurality of anions, a plurality of cations and a solvent, but not comprising particles of a solid other than an ionic solid;
b. bringing the dispensing end of the reservoir in proximity to a substrate, thereby establishing a first meniscus volume of solution external to the reservoir between the dispensing end of the reservoir and a selected location on the substrate;
c. controlling the vapor pressure of solvent in the atmosphere surrounding the reservoir and the substrate so that the anions and cations precipitate from the solution in the first meniscus volume, thereby initiating growth of the nanofiber at the selected location and forming a second meniscus volume of solution between the dispensing end of the reservoir and precipitated nanofiber material;
d. increasing the separation between the reservoir and the selected location on the substrate while
   i. maintaining the second meniscus between the dispensing end of the reservoir and the previously precipitated nanofiber material, thereby maintaining a second meniscus volume; and
   ii. controlling the vapor pressure of solvent in the atmosphere surrounding the reservoir and the substrate so that anions and cations precipitate from the solution in the second meniscus volume, thereby continuing growth of the nanofiber.

In an embodiment, in step d) the vertical separation between the reservoir and the selected location on the substrate is increased, so that the nanofiber extends at least partially upwards from the surface of the substrate. In an embodiment, the synthesis solution comprises metal cations, resulting in a metal-containing ionic solid. In an embodiment, the solvent is water and the nanofiber is a hydrated salt.

In another aspect, the invention also provides a method for forming a nanofiber of a molecular solid, the method comprising the steps of:
a) providing a reservoir comprising a dispensing end, the dispensing end having an aperture less than or equal to 20 micrometers in diameter and the reservoir containing a synthesis solution comprising non-ionic solute molecules and a solvent, wherein the solute molecules are not polymeric;
b) bringing the dispensing end of the reservoir in proximity to a substrate, thereby establishing a first meniscus volume of solution external to the reservoir between the dispensing end of the reservoir and a selected location on the substrate;
c) controlling the vapor pressure of solvent in the atmosphere surrounding the reservoir and the substrate so that the solute molecules precipitate from the solution in the first meniscus volume, thereby initiating growth of the nanofiber at the selected location and forming a second meniscus volume of solution between the dispensing end of the reservoir and precipitated nanofiber material;
d) increasing the separation between the reservoir and the selected location on the substrate while
   i) maintaining the second meniscus between the dispensing end of the reservoir and the previously precipitated nanofiber material, thereby maintaining a second meniscus volume; and
   ii) controlling the vapor pressure of solvent in the atmosphere surrounding the reservoir and the substrate so that solute molecules precipitate from the solution in the second meniscus volume, thereby continuing growth of the nanofiber.

In another embodiment, nanofibers can be formed through rapid evaporation of liquid from a dispersion of colloidal particles, resulting in aggregation and deposition of the particles. The nanofiber formation process is similar to the precipitation-based process previously described.

In another aspect, the invention provides a method for forming an nanofiber of aggregated colloidal particles, the method comprising the steps of:
a. providing a reservoir comprising a dispensing end, the dispensing end having an aperture less than or equal to 10 micrometers in diameter and the reservoir containing a mixture of colloidal particles in a liquid, wherein the liquid is an organic solvent and the particles are dispersed in the liquid;
b. bringing the dispensing end of the reservoir in proximity to a substrate, thereby establishing a first meniscus volume of solution external to the reservoir between the dispensing end of the reservoir and a selected location on the substrate;
c. controlling the vapor pressure of the liquid in the atmosphere surrounding the reservoir and the substrate so that the colloidal particles precipitate from the liquid in the first meniscus volume, thereby initiating growth of the nanofiber at the selected location and forming a second meniscus volume of solution between the dispensing end of the reservoir and precipitated nanofiber material;
d. increasing the separation between the reservoir and the selected location on the substrate while
   i. maintaining the second meniscus of liquid and colloidal particles between the dispensing end of the reservoir and the previously precipitated particles, thereby maintaining a second meniscus volume; and
   ii. controlling the vapor pressure of the liquid in the atmosphere surrounding the reservoir and the substrate so that colloidal particles precipitate from the solution in the second meniscus volume, thereby continuing growth of the nanofiber.

In another aspect, a metal salt or hydrated metal salt nanofiber made by the methods of the invention may be converted to a nanostructure of another composition, such as a metal oxide. The synthesis solution typically comprises metal cations in order to form a metal-containing ionic solid. Metal oxides can be formed through thermal degradation of metal-containing ionic solids, as is known in the art. During the thermal degradation process, the nanofiber form may be maintained or it may be changed to another form. For example, the nanofiber may collapse into ribbon form.

In an embodiment, the invention provides a method for forming a metal oxide nanostructure, the method comprising the steps of:
a) forming a nanofiber of an metal-containing ionic solid or hydrated metal-containing ionic solid according to the methods of the invention; and
b) converting the metal-containing ionic solid or hydrated metal-containing ionic solid to form a metal oxide, thereby forming a metal oxide nanostructure.

In another aspect, metal oxide nanostructures made by the methods of the invention may be converted wholly or in part to metallic form. Metal oxides can be reduced to metallic form as is known to the art.

In an embodiment, the invention provides a nanofiber coil wound around a spool or central core, the nanofiber being made by any of the methods of the invention. In this case, the coil may be started by being drawn by linear translation along the circumference of the stationary spool for a short distance and then may be drawn by continuous rotation of the spool. The separation between the reservoir and a selected location on the spool may be increased at least in part by simultaneously rotating the spool and translating the spool along its axial direction, thereby winding the nanofiber around the spool to form a coil. The smallest achievable inner diameter of the coil depends upon the flexibility of the nanofiber material. In different embodiments, the inner diameter of the coil is greater than or equal to 250 micrometers, 500 micrometers, or 1 mm. In an embodiment, the other diameter of the coil is less than or equal to 100 micrometers, 150 micrometers, 200 micrometers, 250 micrometers, 500 micrometers, or 1 mm. The highest density of the coil (number of turns) is determined by the thickness of the nanofiber; the fiber loops may be wound so closely that they are almost touching. In an embodiment, the coil density is at least 10/mm, 25/mm, 50/mm, 100/mm, 250/mm, 500/mm, 750/mm or 1000/mm, 5000/mm or 10,000/mm. In another embodiment, the separation between the coils is less than or equal to 100 micrometers, 50 micrometers, 25 micrometers, 10 micrometers, 5 micrometers, or 1 micrometer.

In an embodiment, a nanofiber coil of a metal-containing ionic solid is converted through one or more chemical reactions to a metallic coil, thereby providing a high density miniaturized coil. In an embodiment, the spool may be formed of a magnetically soft material, thereby providing a miniature solenoid.

In another aspect, the invention also provides methods for producing coated nanostructures comprising the steps of forming a nanofiber according to any of the methods of the invention and coating the nanofiber with a material selected from the group consisting of a metal or metal alloy, carbon, or a polymer.

Nanostructures produced by the methods of the invention can also be used as soluble templates. For example, nanofibers made by the processes of the invention can be coated with a different material and then dissolved with a liquid which acts as a solvent for the nanofiber material, but not the coating material, thereby forming a tubular structure having a bore diameter less than 1 micrometer. This tubular structure may be a nanotube. Nanofluidic networks and biocompatible scaffolds can also be replicated from such soluble templates. Suitable coating materials include, but are not limited to, metal or metal alloys, carbon, or polymers, or ceramics. In an embodiment, the coating material is selected from the group consisting of a metal or metal alloy, carbon, or a polymer.

### BRIEF DESCRIPTION OF THE DRAWINGS

FIG. 1a: Schematic representation of a nanofiber growth process in which the pipette is moved in the direction perpendicular to the substrate.

FIG. 1b: Schematic representation of continuous winding around spool (60) during growth of a nanofiber (50) forming a nanofiber roll (100).

FIG. 2a: Array of CuSO₄ nanofibers suspended across an approximately 1 mm wide gap fabricated in a silicon chip.

FIGS. 2b and 2c: Multilayered CuSO₄ nanofiber fabric on a surface, at lower (FIG. 2b) and higher (FIG. 2c) magnification.

FIGS. 3a-c: CuSO₄ nanofiber roll, in which a CuSO₄ nanofiber is wound around a spool (the fibers was coated with a thin Au/Pd layer for protection) at increasing magnifications. FIG. 3a is the lowest magnification shown.

FIGS. 4a-d: An array of CuSO₄ nanofibers drawn with a glass pipette. FIG. 4a shows the uncoated array; FIG. 4b shows the array after application of a thin metal coating. FIG. 4c shows an ultra-thin and smooth nanofiber of the array. FIG. 4d shows the curling of nanofibers after the coating of such long nanofibers.

FIG. 5a: Plot of fiber diameter versus drawing speed obtained in a continuous drawing process using a pipette having an aperture diameter of 5 micrometers.

FIG. 5b: Plot of fiber diameter versus drawing speed obtained in a continuous drawing process using a pipette having an aperture diameter of 0.4 micrometers.

FIG. 6a: a curled KOH nanofiber drawn with a glass pipette containing 0.05 M KOH solution.

FIG. 6b: an array of glucose nanofibers drawn with a glass pipette containing an aqueous solution of glucose.

FIG. 6c: a long glucose nanofiber.

FIGS. 7a-7c: SEM, bright field optical microscope and fluorescence microscope images (respectively) of quantum dot nanofibers.

FIG. 7d: CuO ribbon formed by heating of a CuSO₄ nanofiber.

FIG. 7e: CuSO₄ nanofiber deposited directly onto the tip end of a glass pipette. The inset shows a higher magnification image.

### DETAILED DESCRIPTION OF THE INVENTION

The methods of the invention can be used to form one or more nanostructures, also referred to as nano-sized structures. As used herein, a nanostructure has at least one dimension in the range between 1 nm and 1000 nm. In an embodiment, the nanostructure is elongated and has a lateral dimension (such as the diameter) in the range between 1 nm and 1000 nm, between 25 nm and 750 nm, between 50 nm and 750 nm, or between 50 and 500 nm. In an embodiment, the nanostructure is substantially nonporous. In an embodiment, the nanostructure is a nanowire or nanofiber. As used herein, a nanowire or nanofiber is a solid elongated column-like structure. The nanowires or nanofibers of the invention may display some variation of lateral dimension or diameter along the length of the nanostructure. In an embodiment, the nanowire or nanofiber is broader at the substrate end than the free end. In different embodiments, the aspect ratio (ratio of length to diameter) of the nanowire or nanofiber is greater than 5, greater than 10, greater than 100, greater than 1000, greater than 10,000, greater than 100,000 or even greater than 1 million. A nanowire or nanofiber may be straight, bent or coiled. In another embodiment, the nanostructure may be a tube, having an interior passage or lumen. Either the inner diameter or the outer diameter of the tube may have a dimension between 1 nm and 1000 nm.

The methods of the invention can also be used to form one or more micro-sized structures. As used herein, a micro-sized structure has at least one dimension in the range from 1 micron to 1000 micron. In an embodiment, the micro-sized structure is elongated and has a lateral dimension (such as a diameter) in the range from 1 micrometer to 10 micrometers or from 1 micrometer to 5 micrometers. In different embodiments, the micro-sized structure is a wire, fiber or tube.

In an embodiment, the elongated structures of the invention extend at least partially or fully upwards (away from) from the surface of the substrate. In an embodiment, a structure of the invention extends upwards so that the height of the structure above the substrate surface is at least greater than the lateral dimension of the structure (e.g. the diameter of the structure). In other words, the longitudinal axis of each structure is oriented so that it is not completely parallel to the surface of the substrate. In different embodiments, the height of the structure is greater than 250 nm, greater than greater than 500 nm, greater than one micrometer, or greater than 5 micrometers.

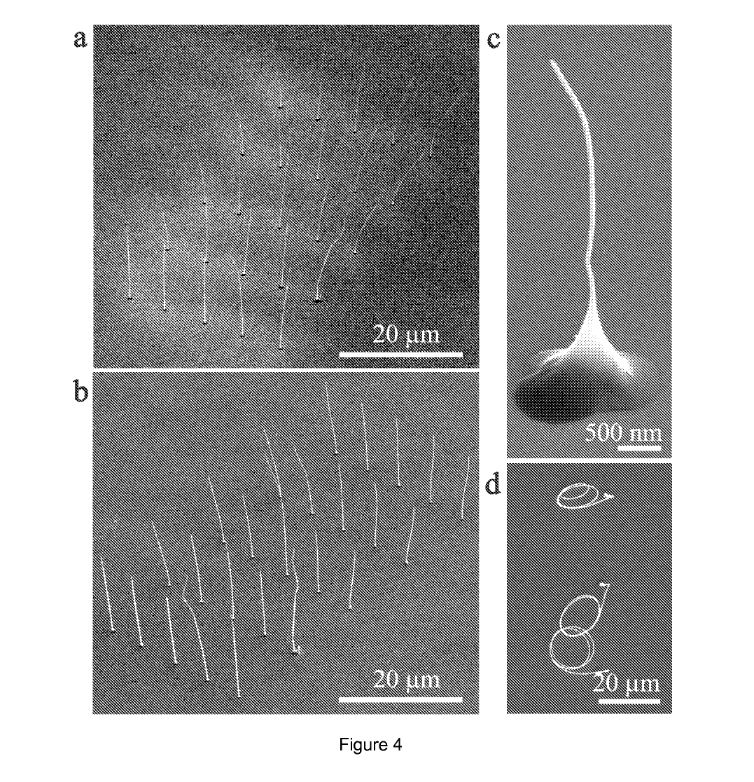

Structures provided by the methods of the invention include a variety of shapes, including, but not limited to, substantially straight nano or micro-sized wires, fibers or tubes whose longitudinal axes are substantially perpendicular to the surface of the substrate (where the structure is attached to the surface). FIGS. 4a-4d show examples of such structures. Structures provided by the invention also include those whose longitudinal axes are neither parallel nor perpendicular to the surface of the substrate at the site of attachment. Structures of the invention also include curved or bent nano or micro-sized wires, fibers or tubes whose longitudinal axis has a varying orientation with respect to the surface of the substrate.

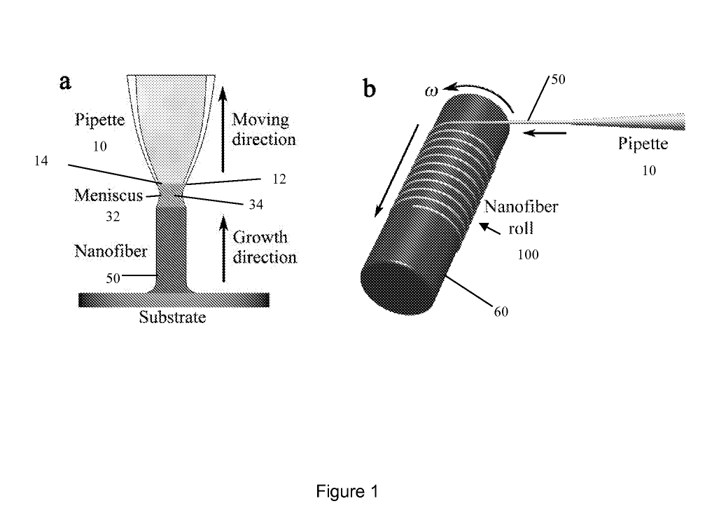

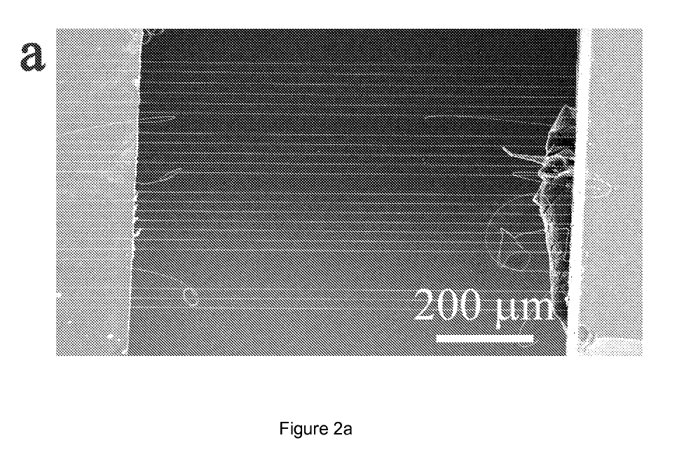

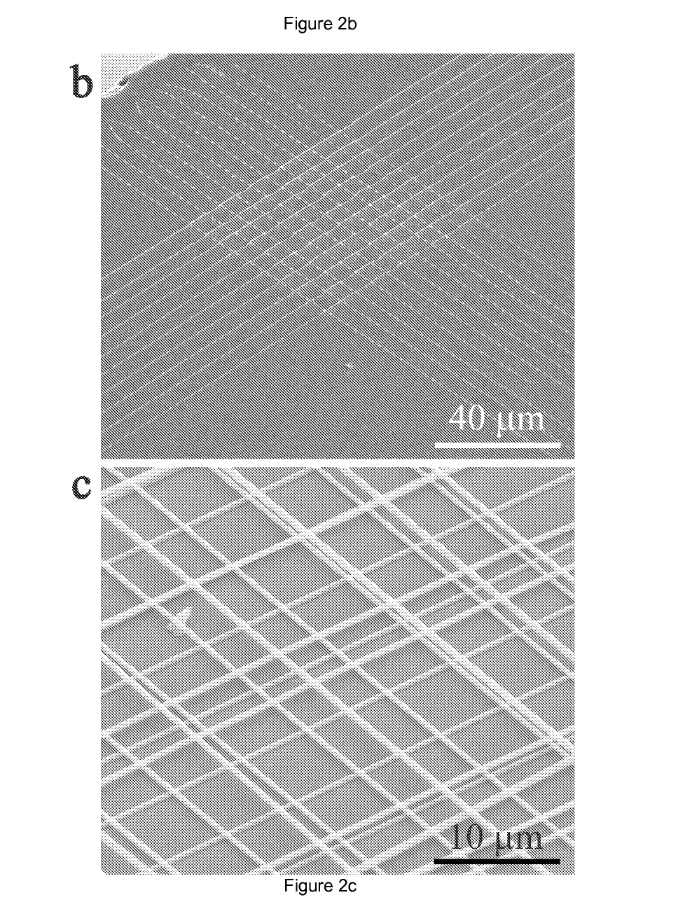

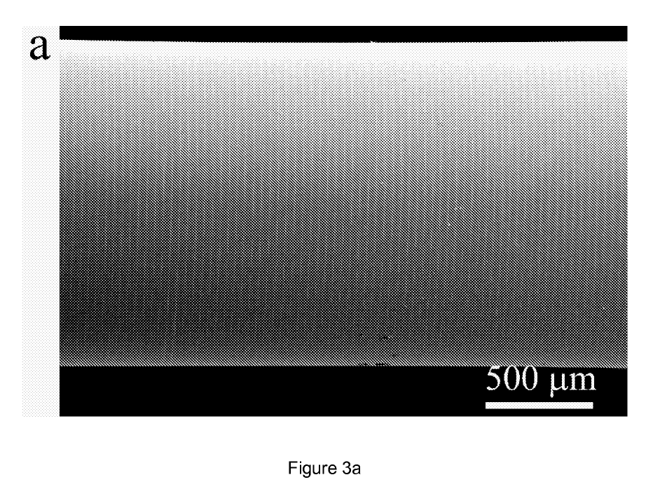

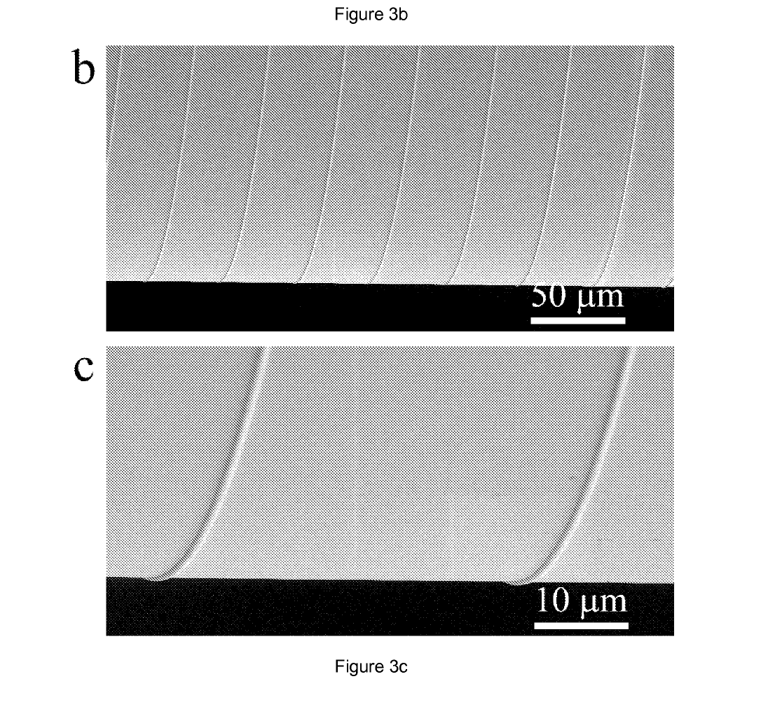

In another embodiment, the elongated structures may be parallel to the substrate surface after formation. Such a structure may be formed by drawing the fiber at a shallow angle with respect to the substrate. In different embodiments, the angle may be greater than zero and less than or equal to 10 degrees or greater than zero and less than or equal to 5 degrees. For example, nanofibers may be formed across a gap in the substrate as shown in FIG. 2a. In an embodiment, the elongated structures may rest on the substrate surface after formation. For example, nanofibers may be wound onto a spool as illustrated in FIG. 1b and FIGS. 3a-3c. As another example, if the nanofibers are sufficiently flexible they may collapse onto the substrate surface after formation. In an embodiment, the elongated structures are not wholly formed by moving the meniscus along the surface of the substrate (if the meniscus is moved along the surface of the substrate, the meniscus will be continually formed between the aperture and the substrate surface).

### Nanofibers of Ionic Solids and Hydrated Ionic Solids

In an embodiment, the nanostructure is a compound formed of at least two species of ions. The compound may be an ionic solid. In an embodiment the ionic solid or salt is water soluble. In an embodiment, the salt is composed of metallic ions and nonmetallic ions, forming a metal salt or metal-containing ionic solid. In an embodiment, metal forming the ion may be selected from the group consisting of alkali metals (Li, Na, K, Rb, Cs), alkaline earth metals (Be, Mg, Ca, Sr, Ba), metals from groups IIIA or IVA of the periodic table (Al, Ga, In, Tl, Sn, Pb) or transition metals (Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg, Lr) or combinations thereof. In an embodiment, the metal may be a transition metal selected from groups IB, IIB, IIB, IVB, VB, VIB, VIIB, or VIIIB of the periodic table or combinations thereof (where group IB includes Cu, Ag, Au, group IIB includes Zn, Cd, Hg and group VIIIB includes Fe, Co, Ni, Ru, Rh, Pd, Os, Ir, and Pt).

As an example, the metal ion may be selected from groups IA (alkali metals) or IIA (alkaline earth metals) of the periodic table and the nonmetallic ion selected from group VIIA (halogens) of the periodic table (e.g. NaCl, MgCl₂, KCl, MgBr₂). Suitable salts of this nature include chlorides, bromides, and iodides. Salts of other metals with halogens may also be soluble in water, but solubility of salts with Ag⁺, Cu⁺ and some other metal ions may be limited.

In another example, the metal may be combined with a polyatomic ion such as a nitrate (NO₃¹⁻), sulfate (SO₄²⁻), carbonate (CO₃²⁻), hydroxide (OH⁻) and/or an organic anion. In an embodiment, the polyatomic ion is selected from nitrate (NO₃¹⁻), nitrite (NO₂¹⁻), chlorate (CIO₃⁻), perchlorate (CIO₄⁻), halogen, acetate (C₂H₃O₂⁻), sulfate (SO₄²⁻), sulfide (S²⁻), borate (BO₃²⁻), carbonate (CO₃²⁻), chromate (CrO₄²⁻), phosphate (PO₄³⁻), sulfite (SO₃²⁻) and hydroxide (OH⁻). In an embodiment, the anion is not an organic anion such as acetate or citrate. In an embodiment, the polyatomic ion is selected from nitrate (NO₃¹⁻), sulfate (SO₄²⁻), and carbonate (CO₃²⁻). In an embodiment, the anion is a sulfate ion. Most metal sulfate salts are soluble in water. Suitable sulfate salts include transition metal sulfates such as CuSO₄, CdSO₄, and CoSO₄. AgSO₄, although less soluble in water, may also be suitable for use with the invention. Suitable carbonate salts include salts of alkali metals. Suitable hydroxide salts include salts of alkali metals. The nanostructures of the invention may also be formed of a mixture of ionic solids, for example a mixed solution of different ionic solids. In an embodiment, the compound is polycrystalline with a crystal size about 10 nm in diameter.

The compound may also incorporate water into the structure so that a hydrated ionic solid or salt is formed. Hydrated forms of salts are known to the art, such as CuSO₄•5H₂O-copper (II) sulphate pentahydrate for copper sulfate. Typically hydrates can be converted to anhydrous form through gentle heating. Heating may influence the grain structure of the nanofiber, typically resulting an increase in grain size. The amount of water incorporated into the nanofiber can be controlled by the choice of solvent or, in some cases, by the chemical composition of the nanofiber (e.g. KCl).

Common inorganic chemical reactions readily available to ionic solids can be applied to convert the as-made ionic fibers to other types of fibers with different physical and chemical properties. In different embodiments, the ionic solid may be oxidized or reduced by exposure to a gas or may be simply decomposed by exposure to heat. Reference works relating to thermal composition of ionic solids are known to the art, and include “Thermal Decomposition of Ionic Solids: Chemical Properties and Reactivities of Ionic Crystalline Phases”, A. K. Galwey, M. E. Brown, Elsevier, 1999. Chapter 9 of this reference relates to thermal dissociation of oxides, Chapter 12 of relates to degradation of carbonates and Chapter 14 relates to degradation of nitrates, sulfates and other compounds.

In an embodiment, nanofibers made of metal containing ionic solids can be converted to metal oxides. Metal sulfates can be reduced to metal oxides by a thermal degradation reaction. For example, by simply heating CuSO₄ fibers in air, such fibers can be converted to CuOₓ fibers or other nanostructures such as ribbons. Metal carbonates can also be converted to metal oxides. For example, a metal carbonate may be converted to a metal oxide by calcination at elevated temperatures in an atmosphere with a low oxygen content.

Metal oxides can then be reduced to metallic form by methods known to the art. For example, a metal oxide can be reduced to metallic form by exposure to a reducing atmosphere. Typically, the reduction reaction will take place at a temperature above ambient temperature. Suitable temperatures for reduction of oxide compositions are known to those in the art. Reducing atmospheres known to the art include, but are not limited to atmospheres comprising carbon monoxide, hydrogen, and/or a hydrocarbon. As an example, CuOx nanostructures can be further converted to Cu fibers through a simple reduction reaction. The same strategy can be applied to convert a wound CuSO₄ nanofiber into a high density miniaturized metallic coil of Cu nanofiber or ribbon.

As another example, some metal sulfates may be directly converted to metallic form in a reducing atmosphere. For example, silver sulfate may be converted to metallic silver by exposure to a hydrogen atmosphere.

As another example, metal sulfates can be converted to metal sulfides. As examples, cadmium sulfate, cobalt sulfate, or zinc sulfate may be converted to CdS, CoS, or ZnS in a suitable atmosphere, such as a hydrogen atmosphere. This approach enables production of sulfur-containing II-VI semiconductor compositions such as CdS or ZnS.

To further take advantage of the chemistry available to ionic solids, nanofibers of mixed ionic solids can be prepared. The chemical reaction between the ionic solids in the fibers can then be directly initiated under the proper conditions, for example, at certain temperature or lighting conditions, to directly convert the ionic solid fibers to other type of fibers.

Suitable synthesis solutions for forming ionic solids comprise a plurality of anions, a plurality of cations, and a suitable solvent. In an embodiment, only one anion species and one cation species is present in the solution. In another embodiment, mixed solutions containing a plurality of anion and/or cation species can be prepared and used to deposit fibers of mixed ionic solids. In an embodiment, the mixed solution does not lead to substantial amounts of precipitation in the reservoir (the different anion and cation species do not undergo a metathesis reaction in the reservoir).

In an embodiment, the solvent is a polar solvent. Suitable polar solvents include, but are not limited to, water, alcohols, acetone, and other organic solvents. The solvent must be sufficiently volatile to allow rapid precipitation of the ions. In an embodiment, the concentration of ionic species in the solution is much below the saturation concentration of the species. In different embodiments, the bulk solution concentration (the initial concentration of the solution in the reservoir) is 1-20%, 1-15% or 1-10% of the equilibrium concentration for a saturated solution. In another embodiment, the concentration of ions in the bulk solution is from 0.01 M to 1 M. In an embodiment, the synthesis solution does not further comprise colloidal particles of a non-ionic solid dispersed in the solvent. The existence of colloidal particles can prevent the growth of long, freestanding and straight nanofibers, as the nanofibers incorporating colloidal particles along with the ionic solid can have lower mechanical rigidity and can be quite soft.

The salt and/or hydrated salt nanostructures produced by the methods of the invention can be very strong and flexible, capable of being bent to a radius of curvature of approximately 100 micrometers.

### Nanofibers of Non-polymeric Molecular Solids

In another embodiment, the nanostructure formed is a molecular solid. In molecular solids, the neutral molecules are held together by non-covalent interactions such as hydrogen bonding or Van der Waals interactions. In an embodiment, the molecular solid is not formed of polymeric molecules. In an embodiment, the molecular weight (MW) of the molecule is less than 1000 (molecules having a MW above 1000 may not be soluble). Suitable molecular solids include those formed of molecules containing more than one chemical species such as crystallizable carbohydrates. In an embodiment, the molecules of the solid are polar. If the molecule allows formation of hydrates, water may be incorporated into these structures as well.

Suitable crystallizable carbohydrates include, for example monosaccharides and the oligosaccharides. Monosaccharides include aldohexoses and ketohexoses. Oligosaccharides include 1,2-disaccharides such as sucrose, 1,4-disaccharides, and 1,6-disaccharides. In an embodiment, the crystallizable carbohydrate is a sugar.

Suitable synthesis solutions for forming molecular solids comprise a plurality of neutral solute molecules, and a suitable solvent. The solute molecules are the molecules which form the molecular solid. The solvent depends on the nature of the solute molecules. If the solute molecules are polar, the solvent can be a polar solvent such as water. If the solute molecules are nonpolar, the solvent can be nonpolar. In an embodiment, the concentration of the solute in the synthesis solution is much below the saturation concentration of the solute. In different embodiments, the bulk solution concentration is 1-20%, 1-15% or 1-10% of the equilibrium concentration for a saturated solution. In another embodiment, the concentration of ions in the bulk solution less than 1 M.

In an embodiment, the sugar nanofibers are quite flexible, and fall onto the surface immediately after growth and after breaking the growth end of the nanofiber from the pipette. However, the overall structures of the sugar nanofibers are intact and kept from disintegration.

### Nanofibers of Colloidal Aggregates

In another embodiment, the nanostructure formed is an aggregate of colloidal particles which are formed prior to the nanostructure formation process. In an embodiment, the particle size is from 1 nm to 10 nm. In an embodiment, the colloidal particles are semiconductor particles. The semiconductor particles may be quantum dots, such as CdSe/ZnS core-shell quantum dots. In an embodiment, the nanostructure does not also contain precipitated ionic solid material.

In this embodiment, the reservoir contains a mixture of pre-formed colloidal particles in a liquid, wherein the particles are dispersed in the liquid. In this embodiment, the concentration of colloidal particles in the mixture is between 0.1 mg/mL and 2.5 mg/mL. In an embodiment, the liquid is an organic liquid such as an aromatic hydrocarbon. In an embodiment, the liquid does not also contain ionic species. In another embodiment, the liquid does not also contain polymeric species (binders).

### The Drawing Process and Apparatus

The establishment of the meniscus can be detected in different ways. In an embodiment, establishment of the meniscus is detected optically (for example by video visualization). For solutions containing ions, establishment of the meniscus can also be detected with ionic current sensing.

To ensure that a meniscus is maintained between the synthesis solution reservoir and the deposit, the rate of separation of the synthesis solution reservoir and the substrate can be controlled by computer-controlled precision piezoelectric motion stages. Desirable pullback speeds can be determined according to prior calibration and real time monitoring under microscope In an embodiment, the pullback speed (drawing speed) is constant and in the range of 5 μm/s to 1 mm/s. To stop formation of the nanostructure, the pullback speed can be reduced and the reservoir moved laterally (e.g. the reservoir can be shook or vibrated) to separate it from the nanostructure.

The reservoir is adapted so that the synthesis solution does not flow from the reservoir during the structure formation procedure unless a meniscus is formed between the dispensing end of the reservoir and the surface on which deposition is to occur. In an aspect of the invention, no external pressure is applied to the synthesis solution to induce synthesis solution flow through the dispensing end of the reservoir. The size of the aperture at the dispensing end is selected to produce the desired lateral dimension of the structure. The reservoir typically includes a second aperture which is usually larger than the dispensing aperture to facilitate filling of the reservoir with synthesis solution. The reservoir may be manually filled with synthesis solution using a syringe inserted into the larger end of the reservoir, or by any other means known to the art. In an embodiment, the aperture at the dispensing end of the reservoir is less than or equal to 20 microns, less than or equal to 10 microns, less than or equal to 5 microns, less than or equal to 2 microns, less than or equal to one micron, less than or equal to 750 nm, less than or equal to 500 nm, less than or equal to 200 nm, less than or equal to 100 nm, less than or equal to 50 nm, less than or equal to 25 nm, between 50 and 750 nm, between 10 nm and 20 microns, between 100 nm and 5 micrometers, between 100 nm and 2 micrometers, between 100 and 750 nm, or between 100 and 500 nm. If the synthesis solution wets the material of the synthesis solution reservoir, the lateral dimension of the meniscus near the dispensing end of the reservoir will typically be larger than the inner diameter (aperture) at the tip of the dispensing end.

In an embodiment, the synthesis solution reservoir is a pipette having an aperture of the desired size. Typically, nanopipets are cylindrical capillary tubes which have a reduced tip diameter. Glass nanopipets having apertures of 500 nm, 200 nm and 100 nm are commercially available. Synthesis solution reservoirs with aperture sizes less than 100 nm, such as 50 nm, may also be suitable for use with the invention. In an embodiment, the minimum aperture size is approximately 10 nm, and maximum size is approximately 20 μm.

In an embodiment, multiple synthesis solution reservoirs may be used to simultaneously deposit multiple structures. In an embodiment, an array of nanostructures can be formed.

The substrate may be planar or nonplanar. In an embodiment, the nanostructures can be collected on a cylindrical spool to form a nanofiber roll (100), as schematically illustrated in FIG. 1b. To start the winding process, a straight nanofiber can be pulled from the edge of the spool by linear translation of the pipette in a process similar to that on a planar surface. The linear translation of the pipette can then be stopped and the spool (60) driven to rotate, which then continuously draws and winds the nanofiber (50) onto the spool until the whole process is stopped. In the winding process, the pipette may be kept stationary.

The diameter of the nanowire or nanofiber is largely determined by the diameter of the meniscus. The diameter of the volume defined by the meniscus depends upon the reservoir aperture diameter, with smaller aperture diameters generally producing smaller nanofiber diameters. In an embodiment, the nanofiber diameter can also be influenced by the pullback speed of the reservoir. It has been found that this dependence is greater for larger aperture diameters. For these larger aperture diameters, the nanofiber diameter decreases with an increase in drawing/pullback speed. In an embodiment, the nanofiber diameter is the same as the meniscus diameter at the liquid/solid interface.

In an embodiment, the vapor pressure of the synthesis solution solvent or colloidal dispersion liquid is controlled to ensure sufficiently rapid evaporation of solvent or dispersion liquid from the meniscus volume. In an embodiment, the vapor pressure of the solvent is at less than ambient level. In an embodiment, dry inert gas flow can be used to maintain the vapor pressure of solvent at a low level. Purging with nitrogen or argon gas for dehumidification is known to the art and such apparatus is commercially available. In an embodiment, the solvent is water and the humidity is controlled to be less than 10%.

In an aspect of the invention, the nanostructures can be coated with another material after synthesis. Therefore, any of the nanostructure fabrication methods of the invention may additionally comprise the step of applying a coating of another material to the nanowire. When the nanostructure is wound on a take-up reel or spool, the coating may take place either prior to or subsequent to the initial winding of the nanostructures on the take-up reel. In an embodiment, the coating process is sufficiently isolated from the deposition process that the coating process does not adversely affect the deposition process. In an embodiment, the nanostructures can be coated by physical vapor deposition techniques. In an embodiment, the nanostructures are coated by sputter deposition. In an embodiment, the coating is a metal or metal alloy coating such as a gold or platinum coating. In another embodiment, the coating is a carbon coating or a polymer coating. A UV-curable polymer coating may be applied as follows. A device containing a UV curable polymer precursor solution (e.g. a monomer solution) can be designed to engage the fiber and allow the fiber to go through the solution during the drawing process, thereby forming a polymer precursor film over the fiber. The precursor film coating can then be immediately cured by UV light to form a continuous protective polymer coating over the fiber. In an embodiment, the coating thickness is from 1-5 nm up to 100 nm. In an embodiment, the minimum thickness is determined by the thickness that can protect the nanofiber from being dissolved by water condensation in humid environment. In an embodiment, the minimum thickness of the protective coating is around 5 nm.

Coated nanostructures provided by the methods of the invention can be treated to dissolve the internal nanostructure, leaving a nanotube. The same templating method may also be applied to a soluble nanofiber array or web for the fabrication of nanochannels and nanofluidic systems.

The invention also provides suitable apparatus for performing the deposition methods of the invention. The apparatus comprises at least one synthesis solution reservoir.

The apparatus also includes at least one process control system which allows monitoring and control of the relative motion of the electrolyte reservoir and the substrate. In an embodiment, the meniscus can be monitored visually, for example with an optical microscope. When the solution contains ions, ionic current sensing can also be used to monitor the meniscus. In an embodiment, the process control system comprises a computer program capable of data acquisition and motion control and a data acquisition card. The software program can control the rate of separation of the reservoir and the substrate so that a stable liquid meniscus of certain size is maintained between these two elements. As an example, LabVIEW software (National Instruments) may be used to control this aspect of the deposition process.

The apparatus includes at least one motion control device operably connected to the reservoir, the substrate or a substrate holder. The motion control device provides for adjustment of the relative positions of the reservoir and substrate during the course of the deposition process. In particular, the motion control device allows control of the separation of the reservoir and substrate in the direction perpendicular to the face of the substrate at the deposition location (the z direction). In an embodiment, the position of at least one of the electrolyte reservoir or substrate is controlled by a motion-control stage. If the substrate position is controlled by the motion-control stage, the platform of the stage will typically provide the substrate holder. In an embodiment, the reservoir is attached to one or more stages which allow precise control of motion along x, y, and z directions. Coarse motion in x, y, and z directions may be provided by one type of stage and fine motion by another type of stage, as is known to those skilled in the art. Suitable stages for this purpose are also known to those skilled in the art and include, but are not limited to, combinations of Burleigh inchworm stages and piezodriven flexure stages. In an embodiment, the relative motion of the substrate and the reservoir is controlled so that the motion is not jerky. In different embodiments, the step size is smaller than 100 nm or 25 nm or less. The quality of motion control can be improved by using smaller step sizes, a better voltage source for driving the piezoelectric stage and better vibration isolation.

The apparatus also can include a device (for example an electrometer) for sensing ionic current during the initial deposition of ionic solid. The ionic current can be used to indicate the initial formation of meniscus between the substrate surface and the pipette. An electric potential is applied between the substrate and the solution in the reservoir during the engagement process of the pipette, as it is being moved towards the substrate surface. The electric potential is chosen to be much smaller than the potential needed to initiate any electrochemical reaction. The appearance of an ionic current signals the formation of meniscus.

In an embodiment, both the synthesis solution reservoir and substrate are placed in an enclosure to enable control of the partial pressure of solvent in the atmosphere surrounding the reservoir and substrate. The enclosure may have an indicator to enable the partial pressure of solvent or humidity. The enclosure may have an inlet to which a humidity control device may be connected. If humidity control is through purging with dry gas, the enclosure has an inlet for gas flow. A heating device, such as a resistive heater, may be placed inside the enclosure to assist in controlling the temperature at which deposition occurs.

An integrated optical microscope system may be incorporated into the apparatus to provide an optical resolution view of the sample. The optical microscope system can facilitate alignment of the reservoir with respect to the substrate.

A vibration isolation device may also be used to improve control of the process. The vibration isolation device is adapted to limit vibration of the substrate, the reservoir and typically the motion control device as well. Suitable vibration isolation devices include, but are not limited to, vibration isolation tables.

A take-up reel or spool can be used to collect the as-formed nanostructures. In an embodiment, the spool may be driven with an electric geared motor to continuously wind the nanofiber. The spool may be precisely aligned to reduce the off-centre rotation. The pipette may be aligned along the tangent direction of the rotation. A short nanofiber may be first drawn along the tangent direction by linear translation, and then drawn solely by the continuous rotation of the spool and wound onto the spool. The spool may driven at an angular speed which corresponds to a suitable drawing speed of, and at the same time is translated along its axial direction.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

Whenever a range is given in the specification, for example, a size range or a time range, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

One skilled in the art would readily appreciate that the present invention is well adapted to carry out the objects and obtain the ends and advantages mentioned, as well as those inherent therein. The methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

All references cited herein are hereby incorporated by reference to the extent not inconsistent with the disclosure herewith.

Although the description herein contains many specificities, these should not be construed as limiting the scope of the invention but as merely providing illustrations of some of the presently preferred embodiments of the invention. For example, thus the scope of the invention should be determined by the appended claims and their equivalents, rather than by the examples given.

The invention may be further understood by the following non-limiting examples.

### EXAMPLE 1

### Fabrication of CuSO₄ Nanofibers

Glass pipettes with an aperture size of 100 nm to several micrometers were used as the reservoirs. The glass pipette was mounted on a platform including an assembly of multiple degrees of freedom piezoelectric mechanical stages with 1 nm fine and 25 nm coarse resolutions. The whole platform was enclosed in a humidity-controlled glove box with a continuous N₂ flow. In the experiment, a solution-containing glass pipette oriented vertical or inclined to a substrate approached the substrate surface until a meniscus was established between the exit of the pipette and the substrate. The glass pipette was then pulled away from the substrate surface along the axial direction of the pipette with a constant speed in the range of 5-μm/s to 1-mm/s. Due to the fast evaporation of solvent in the small meniscus under low humidity condition (controlled at below 10% relative humidity), the solute material in the liquid meniscus nucleates and precipitates. The precipitated solute material deposits first on the substrate surface, and subsequently on the growing solid precipitate confined within the dynamically stable meniscus now formed between the solid growth front and the moving exit of the pipette, as shown in FIG. 1a (this can be observed in video recordings of the fabrication process). The liquid solution was continuously drawn out of the exit of the pipette and evaporated as the pipette is smoothly pulled away from the substrate. This yields a nanofiber made of the solid solute material, with its diameter determined by the size of the meniscus and its length determined by the pull back travel distance of the pipette. The CuSO₄ nanofibers may be at least partially hydrated.

FIG. 2a shows an array of long and uniform diameter (˜250 nm) CuSO₄ nanofibers suspended across a ˜1 mm wide gap fabricated in a silicon chip. The nanofibers were drawn with a 2-μm aperture diameter pipette moving away from the substrate surface along a shallow angle (approximately 5 degrees). The concentration of the aqueous CuSO₄ solution is 0.05 M, the drawing speed is 100 μm/s and the relative humidity in the glove box is ˜8%. The nanofibers were sputter-coated with a ˜20 nm thick Au/Pd film before being transferred out of the glove box. This improved both the imaging quality of the nanofibers in scanning electron microscope (SEM) and, more importantly, protected them from dissolution by water condensation when the relative humidity level was higher than 15% outside the glove box. If the relative humidity is low, no metal coating is necessary and bare CuSO₄ nanofibers can be directly handled in ambient environment and imaged in SEM (see FIG. 4a). The suspended long nanofibers showed enough mechanical strength to withhold the perturbation expected during the sample handling and even the sputter-coating processes. The same procedure was repeated to form a multilayered nanofiber fabric on surface as shown in FIGS. 2b-c.

Continuous drawing of extremely long nanofibers was also realized. A straight nanofiber having a diameter of ˜200 nm and a length of up to 16 mm (limited only by the travel range of the translational mechanical stage) was drawn in this study. This long nanofiber was drawn with an inclined pipette translated at a shallow angle over a silicon substrate surface. The nanofiber sagged onto the surface simply by its own interactions with the substrate during the drawing process (the fiber length was over a millimeter or so when it started to sag)

To realize the continuous production of nanofiber, a 1.55-mm diameter roller driven with an electric geared motor is used to continuously wind nanofiber. The roller was precisely aligned to reduce the off-centre rotation. The pipette was aligned along the tangent direction of the rotation. A short nanofiber was first drawn along the tangent direction by linear translation from a 2-μm diameter pipette containing 0.05 M CuSO₄ solution, and was then drawn solely by the continuous rotation of the roller and wound onto the roller. The roller was driven at an angular speed of approximately 9 turns per hour (equivalent to a drawing speed of approximately 12 μm/s), and at the same time was translated along its axial direction at a speed of approximately 100 nm/s. FIGS. 3a-3c show SEM images of a 90-turn CuSO₄ nanofiber roll (coated with a thin Au/Pd layer for protection). The diameter of the nanofiber is approximately 500 nm, and the length is approximately 45 cm.

By pulling away the pipette along the vertical direction to the substrate surface, freestanding nanofibers were deposited. FIGS. 4a-d show arrays of CuSO₄ nanofibers drawn with a glass pipette having an exit aperture of 100 nm before and after the thin metal coating. The uncoated CuSO₄ nanofibers were insulators, and caused the charging effect in SEM imaging (FIG. 4a). Ultra-thin and smooth nanofibers having diameters down to 25 nm were often made (FIG. 4c), but the involved menisci were delicate and prone to break off from the pipette, which discontinued the drawing process and prevented fabricating long nanofibers. If the freestanding nanofibers were too long, they often deformed into coiled shapes after sputter coating (FIG. 4d).

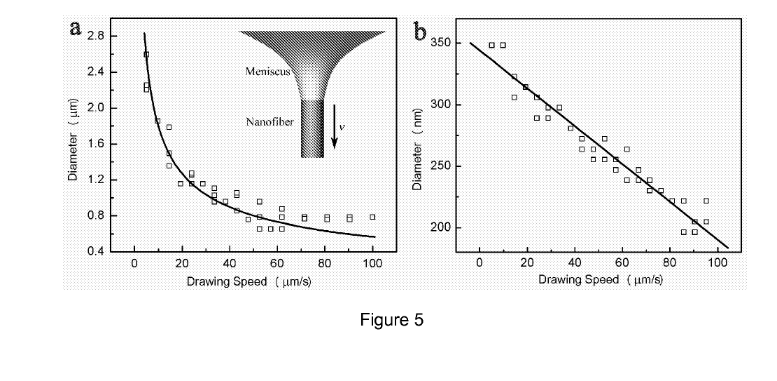

The nanofiber diameter can be effectively controlled by adjusting the drawing speed). Three types of dependence between fiber diameter and drawing speed were observed. For pipette having a large aperture diameter, the dependence was approximately a power law. FIG. 5a shows the plot of fiber diameter versus drawing speed obtained in a continuous drawing process using a pipette having an aperture diameter of 5 μm. The solid line is the fitted curve according to d=av^{1/2}, with a being the fitting constant, a=5.67±0.12. For pipette having a medium-sized aperture (˜400 nm), the dependence became linear (FIG. 5b); and for pipette having an aperture diameter equal to or smaller than 200 nm, the nanofiber diameter was almost independent of the drawing speed. The nanofiber diameter that can be continuously drawn with a 100-nm aperture diameter pipette is around 80 nm. In all cases, a critical drawing speed existed above which the meniscus became unstable and broke off from the pipette. The highest drawing speed realized in this set of experiments was 1 mm/s using a pipette having an aperture diameter of 5 μm in drawing CuSO₄ nanofiber. In certain cases, ultra-small menisci can be initiated especially at the beginning of the drawing process between the pipette and the substrate, which can then lead to the drawing of ultra-small diameter nanofibers as shown in FIG. 4c. The continuous drawing of such ultra-small diameter nanofibers was, however, found to be extremely difficult due to probably the delicate stability of the nanoscale meniscus formation¹². A drawing system with further improved stability and vibration isolation can be used for the continuous drawing of such ultra-small diameter nanofibers. Such diameter-varying nanofibers fabricated in a single drawing process would be ideal elements for the development of hierarchical mechanical structures¹³, which has been so far extremely challenging based on the existing fabrication techniques.

The diameter-drawing speed dependence can be explained by the simple consideration of the meniscus formation and the associated evaporation/precipitation within. As illustrated in the inset of FIG. 5a, for a pipette with a large aperture diameter, the meniscus volume is relatively large. At the instant of change in drawing speed, the resulted increase in meniscus surface area is expected to be small, meaning that the change in evaporation rate of solvent in the meniscus is insignificant as the evaporation rate is proportional to surface area. We can thus assume that the total amount of solute precipitation from the meniscus is constant in this transition, so \dot{m}=pₛπr²v, where \dot{m} is the rate of solute precipitation, pₛ the density of the precipitated solid, r the nanofiber radius and v the drawing speed. An inverse square root dependence of diameter on drawing speed is therefore expected. The same argument follows that as the aperture diameter of the pipette gets smaller, the volume of the established meniscus becomes smaller, and the change in meniscus surface area and so the evaporation rate during the transition can not be ignored. The rate of solute precipitation is then a function of the drawing speed, which eventually negates the dependence between nanofiber diameter and drawing speed described in the previous rate equation.

See also Suryavanshi, A. et al, 2008, Advanced Materials, 20(4), 793-796, which is hereby incorporated by reference.

### EXAMPLE 2

### Formation of Other Nanofiber Compositions

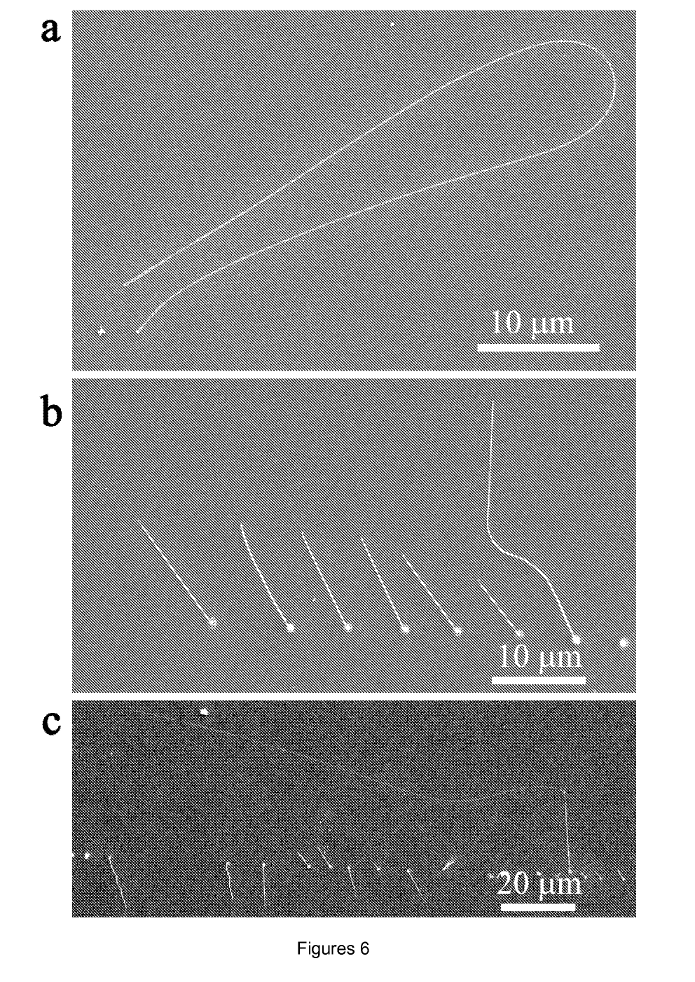

Other types of aqueous solutions have also been used for the nanofiber fabrication, such as KOH, and Carbohydrate (glucose) aqueous solutions (see FIGS. 6a-c). FIG. 6a shows a curled KOH nanofiber drawn with a glass pipette containing 0.05 M KOH solution. FIG. 6b shows an array of glucose nanofibers drawn with a glass pipette containing an aqueous solution of glucose. FIG. 6c shows a long glucose nanofiber. All the fibers shown in FIGS. 6a-6c were coated with an approximately 20 nm thick Au/Pd film with a sputter coater

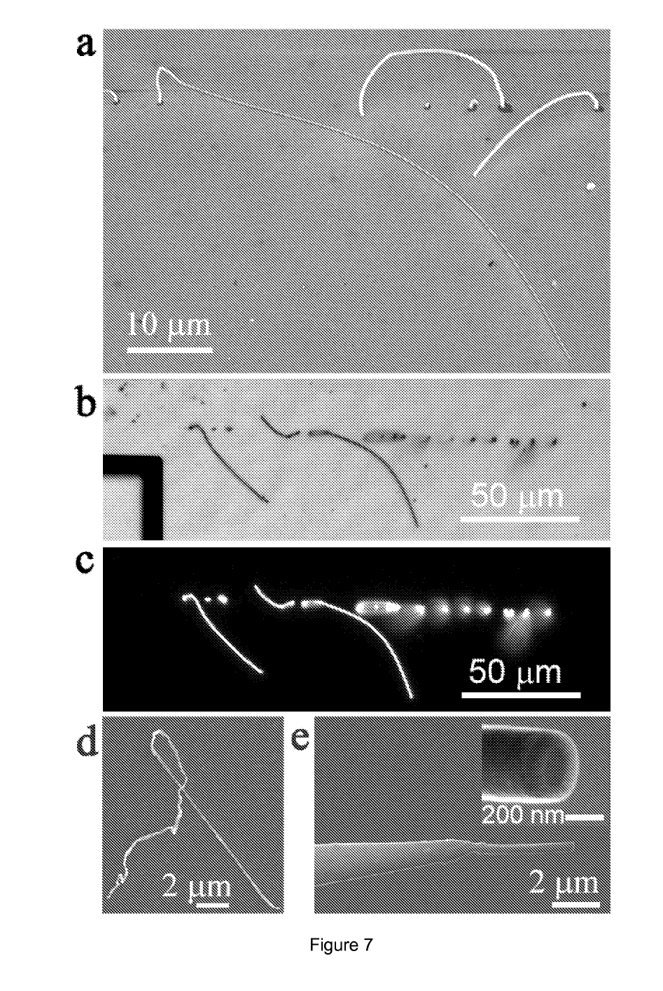

Nanofibers were also made from a toluene solution of CdSe/ZnS core-shell quantum dots (3-6 nm in diameters, Evident Technologies, Inc.). FIGS. 7a-c respectively show the SEM, bright field optical microscope and fluorescence microscope images of quantum dot nanofibers drawn from a glass pipette. As the binding between the quantum dots was expected to be purely van der Waals and thus weak, the fabricated freestanding nanofibers were relatively short and soft, and fell easily onto the substrate surface. They, however, showed no sign of disintegration. These nanofibers, once made, were also insensitive to water condensation, and could therefore survive in ambient environment without a protective coating.

### EXAMPLE 3

### Conversion of Nanofibers from One Composition to Another

For example, upon heating at 600° C. in ambient environment, a long and freestanding CuSO₄ nanofiber was decomposed into a CuO ribbon and collapsed onto the substrate surface (FIG. 7d).

Table 1 shows additional sulfate starting materials and reaction products. Hydrogen gas is shown as a means of converting the sulfate starting materials to the desired product.

TABLE 1

| Starting materials | Product of the reaction |
|---|---|
| Ag2SO4 (solid) + H2 (gas) | Ag |
| CdSO4 (solid) + H2 (gas) | CdS |
| CoSO4 (solid) + H2 (gas) | CoS |

### EXAMPLE 4

### Formation of a Needle Nanopipette

The technique is also not limited to the type of substrate for nanofiber fabrication. FIG. 7e shows a CuSO₄ nanofiber deposited directly onto the tip end of a glass pipette. The glass pipette with the nanofiber attachment was subsequently sputter coated with a 50 nm thick Au/Pd film, and immersed in water to dissolve the solid CuSO₄ core. A needle nanopipette was thus conveniently constructed that can potentially be used for the study of nanofluidics or for the probing of biological or cellular microstructures. The same templating method may also be applied to a soluble nanofiber array or web for the fabrication of nanochannels and nanofluidic systems.

### REFERENCES

1. Chrisey, D. B. The power of direct writing. Science 289, 879-881 (2000).

2. Piner, R. D. et al. Dip pen nanolithography. Science 283, 661-663 (1999).

3. Salaita, K. at al. Massively parallel dip-pen nanolithography with 55000-pen two-dimensional arrays. Angew. Chem. Int. Ed. 45, 7220-7223 (2006).

4. Cumpston, B. H. et al. Two-photon polymerization initiator for three-dimensional optical data storage and microfabrication. Nature 398, 51-54 (1999).

5. Campbell, M. et al. Fabrication of photonic crystals for the visible spectrum by holographic lithography. Nature 404, 53-56 (2000).

6. Sirringhaus, H. et al. High-resolution inkjet printing of all-polymer transistor circuits. Science 290, 2123-2126 (2000).

7. Suryavanshi, A. P. & Yu, M.-F. Probe-based electrochemical fabrication of freestanding Cu nanowire array. Appl. Phys. Lett. 88, 083103 (2006).

8. Suryavanshi, A. P. & Yu, M.-F. Electrochemical fountain pen nanofabrication (ec-fpn) of vertically grown platinum nanowires. Nanotechnology 18, 105305 (2007).

9. Gratson, G. M., Xu, M. & Lewis, J. A. Direct writing of three-dimensional webs.

428, 386 (2004).

10. Ondarcuhu, T. & Joachim, C. Drawing a single nanofibre over hundreds of microns. Europhys. Lett. 42, 215-220 (1998).

11. Harfenist, S. A. et al. Direct drawing of suspended filamentary micro- and nanostructures from liquid polymers. Nano Lett. 4, 1931-1937 (2004).

12. Maeda, N., lsraelachvili, J. N. & Kohonen, M. M. Evaporation and instabilities of microscopic capillary bridge. Proc. Natl. Acad. Sci. USA 100, 803-808 (2007).

13. Yao, H. & Gao, H. Mechanics of robust and releasable adhesion in biology: Bottom-up designed hierarchical structures of gecko. J. Mech. Phys. Solids 54, 1120-1146 (2006).

1. A method for forming a nanofiber of an ionic solid or hydrated ionic solid, the method comprising the steps of:
a. providing a reservoir comprising a dispensing end, the dispensing end having an aperture less than or equal to 20 micrometers in diameter and the reservoir containing a synthesis solution comprising a plurality of anions, a plurality of cations and a solvent, but not comprising particles of a solid other than an ionic solid;
b. bringing the dispensing end of the reservoir sufficiently close to a substrate to establish a first meniscus between the dispensing end of the reservoir and a selected location on the substrate, thereby establishing a first meniscus volume of solution external to the reservoir;
c. controlling the vapor pressure of solvent in the atmosphere surrounding the reservoir and the substrate so that anions and cations precipitate from the solution in the first meniscus volume, thereby initiating growth of the nanofiber at the selected location and forming a second meniscus volume of solution between the dispensing end of the reservoir and precipitated nanofiber material; and
d. increasing the separation between the reservoir and the selected location on the substrate while
i) maintaining the second meniscus between the dispensing end of the reservoir and the previously precipitated nanofiber material, thereby maintaining a second meniscus volume; and
ii) controlling the vapor pressure of solvent in the atmosphere surrounding the reservoir and the substrate so that anions and cations precipitate from the solution in the second meniscus volume, thereby continuing growth of the nanofiber.

2. The method of claim 1 wherein the synthesis solution comprises metal cations and sulfate anions.

3. The method of claim 1 wherein the solvent is water and the nanofiber is a hydrated salt.

4. The method of claim 1, wherein the concentration of ions in the solution is from 0.01 M to 1 M.

5. The method of claim 1, wherein in step d) the vertical separation between the reservoir and the selected location on the substrate is increased, so that the nanofiber extends at least partially upwards from the surface of the substrate.

6. A method for forming a metal oxide nanostructure, comprising the steps of:
a) forming a nanofiber of an metal-containing ionic or hydrated metal-containing ionic solid according to the method of claim 1; and
b) converting the metal-containing ionic solid or hydrated metal-containing ionic solid to a metal oxide, thereby forming a metal oxide nanostructure.

7. The method of claim 6, wherein the metal oxide nanostructure is a nanofiber.

8. A method for forming a metallic nanostructure, comprising the steps of:
a) forming a metal oxide nanostructure according to the method of claim 6;
b) reducing at least a portion of the metal oxide to a metal, thereby forming a metallic nanostructure.

9. A method for forming a nanofiber of a molecular solid, the method comprising the steps of:
a) providing a reservoir comprising a dispensing end, the dispensing end having an aperture less than or equal to 20 micrometers in diameter and the reservoir containing a synthesis solution comprising non-ionic solute molecules and a solvent, wherein the solute molecules are not polymeric;
b) bringing the dispensing end of the reservoir sufficiently close to a substrate to establish a first meniscus between the dispensing end of the reservoir and a selected location on the substrate, thereby establishing a first meniscus volume of solution external to the reservoir;
c) controlling the vapor pressure of solvent in the atmosphere surrounding the reservoir and the substrate so that solute molecules precipitate from the solution in the first meniscus volume, thereby initiating growth of the nanofiber at the selected location and forming a second meniscus volume of solution between the dispensing end of the reservoir and precipitated nanofiber material; and
d) increasing the separation between the reservoir and the selected location on the substrate while
i. maintaining the second meniscus between the dispensing end of the reservoir and the previously precipitated nanofiber material, thereby maintaining a second meniscus volume; and
ii. controlling the vapor pressure of solvent in the atmosphere surrounding the reservoir and the substrate so that solute molecules precipitate from the solution in the second meniscus volume, thereby continuing growth of the nanofiber.

10. The method of claim 9, wherein the solute molecules are molecules of a crystallizable carbohydrate.

11. The method of claim 10, wherein the solute molecules are selected from the group consisting of monosaccharides and oligosaccharides.

12. The method of claim 9, wherein the solvent is water.

13. The method of claim 9, wherein the concentration of solute in the reservoir solution is less than 1 M.

14. The method of claim 9, wherein in step d) the vertical separation between the reservoir and the selected location on the substrate is increased, so that the nanofiber extends at least partially upwards from the surface of the substrate.

15. A method for forming an nanofiber of aggregated colloidal particles, the method comprising the steps of:
a. providing a reservoir comprising a dispensing end, the dispensing end having an aperture less than or equal to 10 micrometers in diameter and the reservoir containing a mixture of colloidal particles in a liquid, wherein the liquid is an organic solvent and the particles are dispersed in the liquid;
b. bringing the dispensing end of the reservoir sufficiently close to a substrate to establish a first meniscus between the dispensing end of the reservoir and a selected location on the substrate, thereby establishing a first meniscus volume of liquid and colloidal particles external to the reservoir;
c. controlling the vapor pressure of liquid in the atmosphere surrounding the reservoir and the substrate so that colloidal particles precipitate from the liquid in the first meniscus volume, thereby initiating growth of the nanofiber at the selected location and forming a second meniscus volume of solution between the dispensing end of the reservoir and precipitated nanofiber material; and
d. increasing the separation between the reservoir and the selected location on the substrate while
i) maintaining the second meniscus of liquid and colloidal particles between the dispensing end of the reservoir and the previously precipitated particles, thereby maintaining a second meniscus volume; and
ii) controlling the vapor pressure of the liquid in the atmosphere surrounding the reservoir and the substrate so that colloidal particles precipitate from the solution in the second meniscus volume, thereby continuing growth of the nanofiber.

16. The method of claim 15, wherein the colloidal particles are semiconductor particles having a size between 1 nm and 10 nm.

17. The method of claim 15, wherein the liquid is selected from the group consisting of toluene, water, acetone, and other volatile organic solvents.

18. The method of claim 15, wherein the concentration of colloidal particles in the mixture is between 0.1 mg/mL and 2.5 mg/mL.

19. A method of forming a nanofiber coil, the method comprising forming a nanofiber according to the method of claim 1 wherein the substrate in step a) is a spool and in step d) the separation between the reservoir and the selected location on the spool is increased at least in part by simultaneously rotating the spool and translating the spool along its axial direction, thereby winding the nanofiber around the spool to form a coil.

20. The nanofiber coil of claim 19, wherein the nanofiber coil is a metallic copper coil formed by conversion of a coil of a copper salt or hydrated copper salt.

21. A method for forming a nanotube comprising the steps of
a. forming a nanofiber according to the method of claim 1;
b. coating the nanofiber with a material selected from the group consisting of a metal or metal alloy, carbon, or a polymer; and
c. dissolving the nanofiber in a solvent, thereby forming a nanotube.

22. The method of claim 21 wherein the nanofiber is coated with a metal or metal alloy.

23. The method of claim 22, wherein the coating is between 10 nm and 100 nm thick.

24. The method of claim 23, wherein the metal is gold, platinum, palladium, or combinations thereof.
